(19) United States
(12) Patent Application Publication
(10) Pub. No.: US 2002/0013894 A1
(43) Pub. Date: Jan. 31, 2002

(54) Data processor with branch target buffer

(76) Inventor: Jan Hoogerbrugge, Eindhoven (NL)

Correspondence Address: U.S. Philips Corporation, 580 White Plains Road, Tarrytown, NY, 10591, US

(21) Appl. No.: 09/908,604

(22) Filed: Jul. 19, 2001

(30) Foreign Application Priority Data
Jul. 21, 2000 (EP) 00202645.8

(51) Int. Cl. G06F 9/00

(52) U.S. Cl. 712/238

(57) ABSTRACT

A data processor comprising contains a branch target memory that stores partial branch target information for instructions. The branch target information is used for advanced determination of the target address of a branch, so that the instruction at the target address can be prefetched. The partial branch target information indicates a position of an expected branch target address in a part of instruction address space defined relative to the current instruction address. Preferably, the relevant part of instruction address space is a page that contains the current instruction address, the partial branch target information providing only the least significant part of the branch target address. FIG. 1

The field of the invention is data processing and more in particular data processing in which an instruction is prefetched before it has been possible to interpret a previous instruction to determine whether a branch change in program flow may occur.

The delay between addressing an instruction in instruction memory and reception of the addressed instruction from the instruction memory is a factor that may slow down execution of instructions by a data processor. To reduce this slow down, instructions are preferably prefetched, i.e. the address of a current instruction is issued as soon as possible after issuing the address of a previous instruction, before the execution of the previous instruction has been completed, in the extreme even before the previous instruction has been decoded.

This may lead to prefetching of the wrong instruction when the previous instruction is a branch instruction. To counteract this problem, it is known to store the target addresses of branch instructions in a memory, called the “branch target buffer” (BTB) that can be addressed with the instruction address of the branch instruction. When the instruction address of the current instruction has to be determined, the address of the previous instruction is used to address the BTB. If the BTB stores the address of a branch target for the address of the previous instruction, that address of the branch target may be used as current instruction address to prefetch the current instruction. Thus, the current instruction address from which the current instruction is prefetched can be determined even before the previous instruction has been decoded. Of course, the current instruction address that is determined in this way is only a prediction. If it turns out that the wrong instruction has been prefetched in this way, the correct instruction will be fetched later on.

From an article by Barry Fagin and Kathryn Russel, titled “Partial resolution in branch target buffers” and published in the Proceedings of the 28^{th} Annual International Symposium on Microarchitecture, pages 193-198, Ann Arbor Mich., Nov. 29-Dec. 1, 1995, it is known to use a branch target buffer (BTB).

The branch target buffer has to be a very fast memory and it will be accessed in every instruction cycle. This has the result that the branch target buffer consumes considerable electrical power. It is desirable to reduce this power consumption and this can be achieved if the size of the memory used in the BTB can be reduced. From the article by Fagin et al. it is known to reduce the size of the BTB a reduction of the associative resolution of the BTB: the BTB is addressed only with a least significant part of the address of the previous instruction

It is an object of the invention to provide for a reduction of the size of a branch target buffer.

A data processing circuit according to the invention is set forth in claim 1 and a method of operating such a data processing circuit is set forth in claim XX. In the circuit and method according to the invention, the branch target buffer does not need to store complete branch target addresses. This reduces the amount of memory needed for the branch target addresses. According to the invention only an update value smaller than a complete branch target address is stored. The current instruction address is selected using the update value as an index indicating a position of the current instruction address in a region defined relative to the previous instruction address, when a branch change of program flow is expected. Of course, in this way the branch target of branches that reach over a long distance cannot be stored. However, it has been found that such long distance branches occur relatively infrequently. Such long distance branches may be handled by storing the complete branch target address for long distance branches or by waiting till execution of the previous instruction produces the required branch target address.

In a preferred embodiment, the update value provides only a less significant part of the current instruction address and the previous instruction address provides a more significant part of the current instruction address. As an alternative, the current instruction address may be obtained by arithmetical addition of the update value to the previous instruction address. The latter has the advantage over the former that it also works for branches that cross a boundary where the more significant part of the instruction address changes (this can occur for branches over any distance). However, the alternative requires execution time for the addition after the time that is already needed to retrieve the update value. This delays the time at which the current instruction may be addressed and therefore slows down execution. To reduce this delay the preferred embodiment is to the update value provides only a less significant part of the current instruction address and the previous instruction address provides a more significant part of the current instruction address.

In embodiment, both update values and absolute branch targets addresses of branch instructions are stored in the branch target buffer for use to determine the current instruction address. When information is retrieved from the branch target buffer for the previous instruction address, dependent on the type of information the information is used directly as current instruction address or to select the current instruction address using the update value and the previous instruction address.

Preferably, the branch target buffer has locations with a size fitted to store the update value, i.e. smaller than the size needed to store an absolute target address, and an absolute address, when stored in the branch target buffer, is distributed over at least two locations for storing update values.

These and other advantageous aspect of the circuit and method according to the invention will be described in more detail using the following figures.

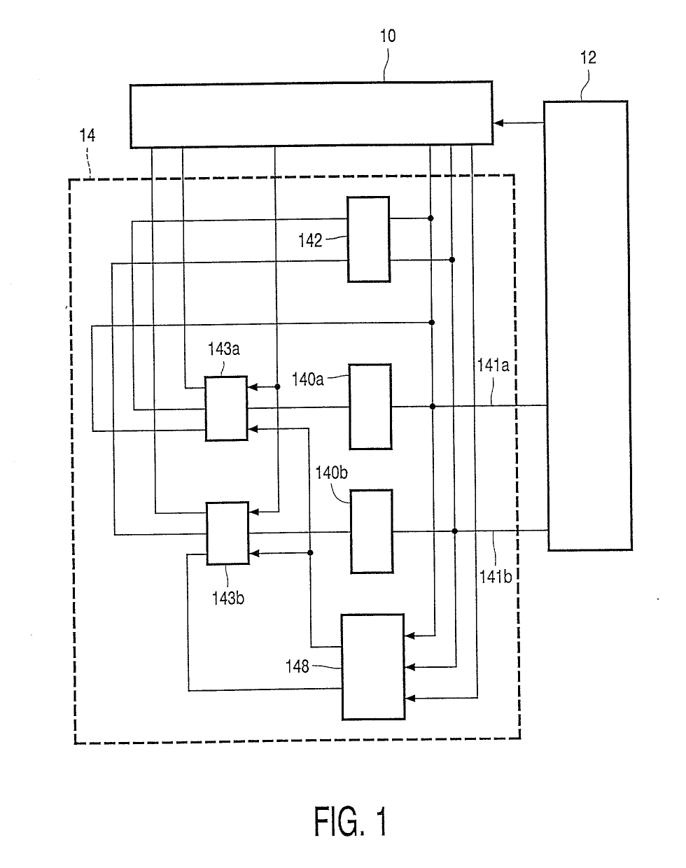

FIG. 1 shows a data processing circuit

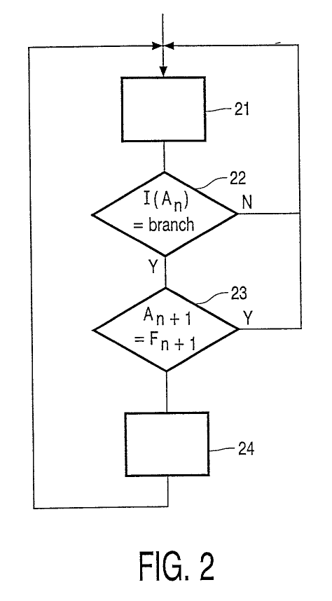

FIG. 2 shows a flow chart for storing branch target information

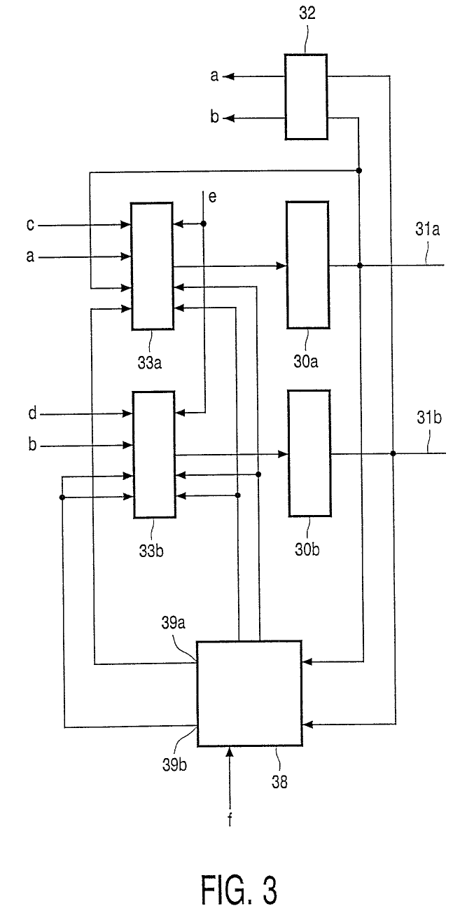

FIG. 3 shows an instruction prefetch unit

FIG. 1 shows a data processing circuit. The data processing circuit contains an instruction execution unit 10, an instruction memory 12 and an instruction prefetch unit 14. The instruction prefetch unit 14 has an instruction address output coupled to an address input of instruction memory 12 and to execution unit 10. The instruction memory 12 has an instruction output coupled to an instruction input of instruction execution unit 10. Execution unit 10 has a control output coupled to instruction prefetch unit 14.

In operation, instruction prefetch unit 14 successively issues instruction addresses to instruction memory 12. Instruction memory 12 retrieves the instructions addressed by the instruction addresses and supplies these instructions to execution unit 10. Execution unit 10 executes the instructions as far as required by program flow. If instruction execution unit 10 detects that the address of an instruction that must be executed does not equal the instruction address that ahs been issued by the instruction prefetch unit 14, instruction execution unit 10 sends a correction signal to instruction prefetch unit 14 to correct the instruction address.

Instruction prefetch unit 14 contains a branch target component and may also contain a branch history component. The branch target component stores information about the instruction addresses to which branch instructions in instruction memory 12 branch. The branch history component stores information to indicate whether or not branch instructions are likely to be taken. If information about a branch target address is available and the branch is likely to be taken, instruction prefetch unit 14 will prefetch instructions from the branch target address. The branch history component is not essential for the invention and is therefore not shown and not described further.

Connections for loading and storing data in memory are not shown in FIG. 1, as they are not needed to understand the invention. During execution, execution unit 10 may require data values from a data memory. A separate data memory (not shown) with its own address and data connections to the execution unit 10 may be provided for this purpose, or the instruction memory 12 may also be used as data memory in time multiplex with instruction fetching.

Instruction prefetch unit 14 contains an N-bit instruction address register 140a,b shown in two parts 140a,b, a first part 140a for storing an N-M bit more significant part of the instruction address and a second part for storing an M bit less significant part of the instruction address (0<M<N). Address outputs 141a,b of the first and second part 140a,b of the instruction address register are coupled to the address input of the instruction memory 14. The instruction prefetch unit furthermore comprises an address incrementation unit 142 and an address multiplexer 142 comprising a first and second part 142a,b. The address outputs 141a,b of the address register 140a,b are coupled to the incrementation unit 142, which has a first and second output, for a more significant and a less significant part of an incremented address respectively, coupled to a first input of the first and second part 143a,b of the address multiplexer respectively. The first and second part 143a,b of the address multiplexer have outputs coupled to the first and second part of the address register 140a,b respectively.

Instruction prefetch unit 14 contains a memory 148 with a (preferably associative-) address input coupled to the address outputs 141a,b of the instruction address register 140a,b, a “hit” signaling output coupled to control inputs of the first and second part of the address multiplexer 143a,b and a branch target information output coupled to a second input of the second part of address multiplexer 143b. The address output 141a of the first part of the instruction address register 140a is coupled to the second input of the first part of the address multiplexer 143a. Memory 148 has a content update input coupled to instruction execution unit 10. Execution unit 10 has an address correction output coupled to a third input of the first and second address multiplexer 143a,b and a multiplexer control output to a further control input of the parts of the address multiplexer 143a,b.

In operation instruction prefetch unit 14 operates synchronously with instruction execution by instruction execution unit 10 under control of an instruction cycle clock (not-shown). Memory 148 stores information about the target addresses of branch instructions in instruction memory 12. This information can be retrieved, if available, by applying the instruction address of the branch instruction to memory 148. Preferably, memory 148 is (set-) associative.

Memory 148 retrieves branch target information addressed by the instruction address received from instruction address register 140. When memory 148 indicates a “hit” (presence of branch target information for the instruction address), this is signaled to address multiplexer 143a,b. In response, the address multiplexer 143a,b passes the N-M more significant bits of the instruction address from the first part of the instruction address register 140a back to the first part instruction address register 140a. Also in response to the detection of the hit, the second part of instruction address multiplexer 143b passes the branch target information retrieved from memory 148 to the second part of the instruction register 140b.

When memory 148 does not report a hit, instruction address multiplexer 143a,b passes the N-M bit more significant part and the M bit less significant part of the output of the address incrementation unit 142 to instruction address register 140a,b. Thus the next instruction address is the address of the instruction that follows the previous instruction in instruction memory 12.

In contrast to this, when memory 148 reports a hit, a next instruction address is loaded into the instruction address register 140a,b that comprises the N-M more significant bits of the previous instruction address and M less significant bits retrieved from memory 148. Thus, only instruction addresses that have the same more N-M significant bits as the previous instruction address can be loaded. The memory 148 stores only the M less significant bits needed for the computation of the address for a number of instruction addresses. The memory is therefore smaller than a memory that would be needed to store complete N bit branch target addresses for the same number of instruction addresses. The precise number M of less significant bit is a matter of compromise between the gain due to smaller memory size and a loss of target address prediction ability because not all possible branch target address values can be represented in this way. It has been found from practical benchmarks that storage of M=10 or more less significant bits of the branch target address in memory 148 gives good (better than 86%) ability to store branch target addresses. Therefor a M=10 or more bit second part of instruction address register 140b and address multiplexer 143b is preferred.

Of course, the next instruction address that is computed in this way may be incorrect. For example because a branch instruction is not taken, or because information about the branch target of a branch instruction is not present. The execution unit 10 detects this by comparing the instruction addresses issued by the instruction prefetch unit 14 with instruction addresses computed as a result of instruction execution. In case of inequality the execution unit 10 outputs the correct instruction address, as computed during instruction execution, to the address multiplexer 143a,b and commands the address multiplexer 143a,b to output the corrected address to instruction register 140a,b.

Some processors have an instruction size that a power of two of the basic unit of addressing instruction memory. For example, the MIPS processor has four byte instructions. In this case, the least significant bits of an instruction address always have the same value. Obviously, in this case, these least significant bits need not be included with the M less significant bits stored in memory 148 or in the instruction address used to address the memory 148. Also some processors, like the MIPS processor, have delayed branch instructions. In this case, one or more instructions that follow the branch instruction in memory are executed before the branch has effect on the instruction address. In this case, memory 148 may delay outputting of the signal that indicates the hit and the less significant part of the branch target address by a corresponding number of instruction cycles after receiving the instruction address of the delayed branch instruction: the branch target address output by memory 148 is the expected branch target of a previous instruction, but not necessarily for the immediately preceding instruction. Also, even if the execution unit does not have delayed branches, it may be desirable to store branch target information for a branch instruction in memory 148 addressed by a previous instruction address that addresses an instruction before the branch instruction, for example to allow more time for memory 148 to retrieve the branch target information.

In FIG. 1, shows the use of the more significant part of the instruction address from the first part of the instruction register 140a as more significant part of the next instruction address. Without deviating from the invention other more significant parts of the next instruction address may be used that have a predefined relation to the previous instruction address in the instruction register 140a. For example, under the following conditions:

If the previous instruction address is less than a first threshold value above a boundary where the more significant part changes (less significant part all zero's ore one's), and

The branch target information provides a value for the less significant part that is above a predetermined second threshold (e.g. a value having a most significant bit equal to one),

then one may use for the next instruction address a version of the more significant part of the previous instruction address that is decremented by one instruction. Thus, the frequency of mispredictions due to crossing of the boundary can be reduced. This works also if output of the previous instruction address is not the instruction address that is issued to the instruction memory 12 immediately before the next instruction address.

As another example the more significant bits of the incremented instruction address from incrementation unit 142 may be used for the next instruction address. Thus, supply of supply of the more significant part of the instruction address from the first part of the instruction register 140a to the first part of the multiplexer 143a may be omitted. When the less significant part of the instruction address that is retrieved from memory 148 is sufficiently large all this makes relatively little difference for the speed of execution because the more significant bits of the instruction address change infrequently due to instruction address incrementation. Instead of coupling back the more significant bits from the first part of the instruction address register 140a, one may also disable updating of this first part of the instruction address register 140a when memory 149 reports a hit. This saves power consumption and reduces the complexity of the circuit.

Preferably memory 148 is a fully associative memory, a set-associative memory or a direct memory. In a direct memory, part of the instruction address received from address output 141a,b is used to address the memory 148 and the memory stores a “tag”, which corresponds to another part of the instruction address from address output 141a,b, and information about the branch target address. The tag is compared with the corresponding part of the instruction address that is applied to the memory 148. If they are equal a hit is reported. In a set associative address a set of tags and branch target information items is stored at a location that is addressed by a part of the instruction address received from address output 141a,b. One or none of these locations is selected, according to whether or not its tag equals a corresponding part of the instruction address received from address output 141a,b. In a fully associative memory branch target information for an instruction address can be stored at any location in the memory 148 and the full instruction address is used as tag.

In order to realize a further reduction of memory size for memory 148, one may provide storage space for only part of the tag, in fully associate memory, set-associative memory or direct memory. To retrieve instruction addresses from memory only the stored part of the tag of instruction addresses is compared to a corresponding part of the previous instruction address received from address output 141a,b. If the parts are equal, a “hit” is reported and the next instruction address is determined using the memory 148. This will lead to less reliable branch target prediction, because it may occur that a remaining part of the instruction addresses that is not compared does not match. But it has been found that the loss execution speed due to less reliable prediction is quite small. With a memory of 128 or 512 locations, 8 or more tag bits have been found to provide satisfactory reliability.

Preferably, the content of the memory 148 is updated during the course of program flow (alternatively, one might load before program execution a predefined content for a number branch instructions that are expected to be executed frequently). For the purpose of this updating the execution unit 10 has an output coupled to an update input of memory 148.

FIG. 2 shows a flow chart for updating the memory 148. In a first step 21, execution unit 10 starts processing an instruction I(A(n)) that has been fetched from instruction memory 12 at address A(n). (n is an indexed used in this description to indicate instruction cycles; n need not be determined by the execution unit 10: A(n) is merely the address of the current instruction, A(n+1) is the address of the next instruction and so on). In a second step 22, execution unit 10 determines whether the instruction I(A(n)) is a branch instruction. If not, the flow-chart repeats for the next instruction cycle (n increased by 1). If the instruction I(A(n)) is a branch instruction, execution unit 10 determines the address A(n+1) of the instruction that must be executed after the branch instruction I(A(n)) and the address F(n+1) of the instruction address issued by the instruction prefetch unit 14 after issuing the address of the branch instruction I(A(n)). In a third step execution unit 10 detects whether A(n+1) equals F(n+1). If so, the branch target, if any, has been predicted correctly and the flow-chart repeats for the next instruction (n increased by 1).

If A(n+1) is not equal to F(n+1), execution unit 10 executes a fourth step 14 in which the M less significant bits of the address A(n+1) of the branch target are stored in memory 148 at a location addressed by the address A(n) of the branch instruction I(A(n)), if the branch instruction I(A(n)) has been taken. Since memory 148 is preferably an associative memory, it may be necessary to choose a memory location for storing A(n+1), thereby overwriting the content of that memory location. The memory location may be chosen according to known cache replacement algorithms such as the LRU (Least Recently Used) algorithm. If A(n+1) is unequal F(n+1) and the branch instruction I(A(n)) is not taken, this means that a branch target address F(n+1) is already present in memory 148 at a location addressed by A(n). In this case, preferably, execution unit 10 leaves this address F(n+1) untouched for later use. After the fourth step 24 the flow-chart proceeds for the next instruction (n increased by 1).

Of course many variations on the algorithm shown in FIG. 2 are conceivable, for example, on might store branch target information only for backward branches, and not for forward branches, since backward branches are expected to be taken more often (e.g. loop branch back). Thus, more memory locations will be available for the most executed (backward branches), which reduces the risk of premature replacement of the targets of these branches in memory 148.

The execution unit 10 may invalidate the branch target information if that branch target information is used to update content of the instruction register 140a,b with an issued address F(n+1), when the issued address F(n+1) turns out to be different from the address A(n+1) of the instruction that must be executed and the instruction I(A(n)) is not a branch instruction or a taken branch instruction that branches to an unpredicted address. This has been found to be particularly useful in the embodiment where only a partial tag is used to retrieve information from memory 148. In that case, memory 148 may produce a “hit” for a wrong instruction address, which happens to have the same partial tag (and the part of the address that is used to address the locations of memory 148 in the case of a direct memory or a set associative memory) as the partial tag for which branch target information has been stored in memory 148. Of course, one might also leave such information valid in memory 148, in the hope that the next hit will not be in error, but it has been found that program execution becomes faster if such information is invalidated.

In the example shown in FIG. 1, only M less significant bits of N bit branch target addresses are stored in memory 148. Preferably, however, provision is made for also storing full branch target addresses, or larger parts of branch target addresses, as an alternative to storing only the M less significant bit address parts. Thus, it is possible to store at least two forms of information: information of M less significant bits or information for a larger part of the branch target address or even a full branch target address. The execution unit 10 stores the smallest form of information that is sufficient to predict the branch target address. For example, if an instruction I at address A has a branch target T and the N-M more significant bits of the address A and the target I are equal, the small form of M bits may be stored and if the N-M more significant bits differ, a larger form of information may be stored, for example a full branch target address.

FIG. 3 shows an instruction prefetch unit that implements storage and use of larger forms of branch target information. The instruction prefetch unit comprises a two part instruction address register 30a,b, an address incrementation unit 32, a two part address multiplexer 33a,b and a memory 38. Instruction address outputs 31a,b of the instruction address register 30a,b are coupled to inputs of the incrementation unit 32 and memory 38. A first part of the address multiplexer 33a has a first input (c) coupled to the instruction prefetch unit (not shown), a second input (a) coupled to an output of the incrementation unit 32, a third input coupled to the address output 31a of a first part of the instruction address register 31a and a fourth input coupled to a first output 39a of memory 38. A second part of the address multiplexer 33b has a first input (d) coupled to the instruction prefetch unit (not shown), a second input (b) coupled to an output of the incrementation unit 32 and a third and fourth input both coupled to a second output 39b of memory 38. The multiplexer 33a,b has control inputs coupled to (e) the instruction prefetch unit (not shown) and the memory 38. Memory 38 has a control input (f) coupled to the instruction execution unit (not shown)

In operation, the instruction prefetch unit of FIG. 3 works similar to the instruction prefetch unit of FIG. 1, except that memory 38 has the option causing the instruction address register 30a,b to load of either a full N bit next instruction address or a reduced (M-bit), less significant part of a next instruction address from memory 38. Memory 28 receives the previous instruction address from the output 31a,b of instruction address register 30a,b. In response to this previous instruction address, memory 38 outputs control signals to address multiplexer 33a,b, indicating whether or not there has been a hit, and whether that hit was for a full branch target address or for a less significant part of a branch target address only. Memory 38 also outputs the full branch target address or the less significant part.

Address multiplexer 33a,b of FIG. 3 functions similar to address multiplexer 143a,b of FIG. 1, except that, when memory 38 signals a hit, the first part of the address multiplexer 33a passes either the N-M bit more significant part of the previous instruction address from the first part of the instruction address register 30a or an N-M bit more significant part from memory 38, dependent on whether or not memory 38 signals that the hit was for a full branch target address or for a less significant part of a branch target address only.

Preferably, memory 38 has memory locations for storing an M-bit less significant part of a branch target address plus information to indicate whether or not a full address branch target address has been stored. In the latter case, the bits of the branch target address are distributed over two logically adjacent locations. When memory 38 receives a previous instruction address, and detect a hit, memory 38 outputs part of the content of the memory first location for which a hit was detected from the second output 39b of memory and information from a second location adjacent to the first location on the first output 39a. If the first location contains information that a full branch target address is to be used, memory 38 signals this to the multiplexer 33a,b. Thus, two locations from memory 38 are used when a full branch target is needed and a single location is used if only a less significant part is needed.

When memory 38 uses (partial) tags to identify the instruction address for which branch target information is stored, this partial tag is not needed for the second location. Memory space for storing the tag of the second location may be used for storing bits of the branch target address. False hits due to a match of these bits with an instruction address supplied to the memory 38 may be suppressed, for example by using a bit of the second location to indicate whether or not tag information is stored, or by consulting the information to indicate whether or not a full address branch target address has been stored from the adjacent first location for this purpose.

In case of a set-associative memory 38, the first and second location are preferably from the same set. Thus, only one set needs to be read at a time.

Without deviating from the invention, more than two memory locations may be used to store a full branch target address if necessary, or the memory 38 may have the option of selecting between more than two alternative lengths of branch target information. For example, four different lengths of M, 2M, 3M bit less significant parts of the branch target address and a full branch target address may be stored alternatively and supplied to the instruction address register 30a,b accordingly.

Also it is not necessary to use logically adjacent memory locations for storing parts of the branch target address, as long as there is a predetermined relation between the memory locations or when information is stored in the memory locations to indicate where the different parts can be found.

The execution unit (not shown) signals to the memory 38 which length of branch target information will be stored in the memory 38, dependent on whether or not a sufficient number of more significant bits of the previous instruction address and the branch target address are equal.

1. A data processor comprising
an instruction memory;
an instruction execution unit for executing instructions from the instruction memory;
an instruction prefetch unit having an instruction address output coupled to the instruction memory for addressing the instructions in advance of execution, the instruction prefetch unit comprising
a branch target memory for storing partial branch target information for the instructions, the branch target memory having an address input, the instruction address output of the prefetch unit being coupled to the address input for supplying a first instruction address to retrieve the partial branch target information for the first instruction address;
an instruction address selection unit arranged to select a second instruction address for issue to the instruction output, using the retrieved partial branch target information to indicate a position of the second instruction address in a part of instruction address space defined relative to the first instruction address, when a branch change of program flow is expected.

2. A data processor according to claim 1, wherein said part of instruction address space is a space of instruction addresses having a more significant part determined from the first instruction address, the update value supplying a less significant part of the second instruction address.

3. A data processor according to claim 1, wherein the branch target memory stores indication whether a the second instruction address must be determined using said part of the instruction address space or using a further address space defined by information stored in the branch target memory, the second instruction address selection unit selecting the instruction address according to the indication when the location is addressed.

4. A data processor according to claim 3, wherein the branch target memory has locations, each suitable for storing the partial branch target information for a different value of the first instruction address, the branch target memory outputting a content of a first location addressed by the first instruction address and of a location having a predetermined relative position with respect to the first location to the instruction address selection unit, at least when the indication indicates that the second instruction address must be determined using the further address space defined by information stored in the branch target memory, the partial branch target information and the information defining the further address space being stored in respective ones of the locations whose positions have the predetermined relative position to one another.

5. A data processor according to claim 4, each locations comprising a space for storing tags, each tag for representing at least part of an instruction address for which partial branch target information is stored in the location, for use in locating the partial branch target information for the first instruction address, said space storing the information which defines the further address space instead of the tag in at least one of the respective ones of the locations when the indication indicates that the second instruction address must be determined using the further address space.

6. A method of execution of instructions by a data processor, the method comprising determining a current instruction address from a previous instruction address, said determining comprising
retrieving information stored about the previous instruction address, the information indicating
whether a branch change of program flow is expected after execution of the instruction at the previous instruction address;
an update value corresponding to the branch change;
selecting the current instruction address using the update value as an index indicating a position of the current instruction address in a region defined relative to the previous instruction address, when the information indicates that the branch change of program flow is expected.

7. A method according to claim 6, wherein said region is a region of instruction addresses having a same more significant part as the previous instruction address, the update value supplying a less significant part of the current instruction address.

8. A method according to claim 6, wherein the information stored about the previous instruction address comprises an indication whether the update value indicates the position in the region or an absolute value of the current instruction address, the current instruction address being selected accordingly.

9. A method according to claim 6, wherein the information is stored in a memory of locations that are addressed associatively with the previous instruction address, the method comprising storing an indication whether the update value indicates the position in the region or whether an absolute value of the current instruction address should be used to determine the current instruction address, the absolute value being stored distributed over at least two of said locations.
